(19) United States
(12) Patent Application Publication
(10) Pub. No.: US 2002/0191004 A1
(43) Pub. Date: Dec. 19, 2002

(54) Method for visualization of hazards utilizing computer-generated three-dimensional representations

(76) Inventors: John Franklin Ebersole, Bedford, NH (US); John Franklin Ebersole JR., Bedford, NH (US)

Correspondence Address: Brian M. Dingman, Esq., Mirick, O'Connell, DeMallie & Lougee, LLP, 1700 West Park Drive, Westborough, MA, 01581, US

(21) Appl. No.: 10/215,567

(22) Filed: Aug. 9, 2002

Related U.S. Application Data
(63) Continuation-in-part of application No. 09/634,203, filed on Aug. 9, 2000.
(60) Provisional application No. 60/349,029, filed on Jan. 15, 2002.

(51) Int. Cl. G09G 5/00

(52) U.S. Cl. 345/633; 345/629

(57) ABSTRACT

A method is presented for visualization of hazards which pose a serious threat to those in the immediate vicinity. Such hazards include, but are not limited to, fire, smoke, radiation, and invisible gasses. The method utilizes augmented reality, which is defined as the mixing of real world imagery with computer-generated graphical elements.

Computer-generated three-dimensional representations of hazards can be used in training and operations of emergency first responders and others. The representations can be used to show the locations and actions of a variety of dangers, real or computer-generated, perceived or not perceived, in training or operations settings. The representations, which may be graphic, iconic, or textual, are overlaid onto a view of the user's real world, thus providing a reality augmented with computer-generated hazards. A user can then implement procedures (training and operational) appropriate to the hazard at hand.

### CROSS REFERENCE TO RELATED APPLICATIONS

This application claims priority of Provisional patent application No. 60/349,029 filed Jan. 15, 2002. This application is a Continuation in Part of “Augmented Reality Navigation Aid” Ser. No. 09/634,203 filed Aug. 9, 2000.

### FIELD OF THE INVENTION

This invention relates to emergency first responder (EFR) visualization of hazards in operations and training; and to augmented reality (AR).

### COPYRIGHT INFORMATION

A portion of the disclosure of this patent document contains material that is subject to copyright protection. The copyright owner has no objection to the facsimile reproduction by anyone of the patent document or the patent disclosure as it appears in the Patent and Trademark Office records but otherwise reserves all copyright works whatsoever.

### BACKGROUND OF THE INVENTION

Today's emergency first responders (hereafter referred to as EFRs) may be dispatched to highly dangerous scenes which visually appear to be relatively normal. For example, certain chemical compounds involved in a spill situation can transform into invisible, odorless gas, yet potentially be harmful to EFR personnel and victim(s). There are also types of hazards which may not be visible at any stage (e.g., radiation leaks) that pose a serious threat to those in the immediate vicinity. In order to prepare EFRs for these types of incidents, these situations must be anticipated and presented within the training environment. Furthermore, in order to maintain a high level of proficiency in these situations, frequent re-education of professionals within first responder fields is called for to ensure that proper procedures are readily and intuitively implemented in a crisis situation.

Current EFR training is limited to traditional methods such as classroom/videotape and simulations such as live fire scenarios. Classroom and videotape training do not provide an environment which is similar to an actual incident scene; therefore, a supplementary method is required for thorough training. Simulations are done via simulator equipment, live fire, and/or virtual reality. Simulations using live fire and other materials can pose unacceptable risk to trainees and instructors; other types of simulations may occur within an environment which is not realistic enough to represent an actual incident scene.

An EFR/trainee able to “see” an otherwise unseen hazard will be better able to implement the correct procedures for dealing with the situation at hand. This application describes a method, which is “harmless” to the EFR/trainee, for visualizing unseen hazards and related indicators. Operational and training settings implementing this method can offer EFRs/trainees the ability to “see” hazards, safe regions in the vicinity of hazards, and other environmental characteristics through use of computer-generated three-dimensional graphical elements. Training and operational situations for which this method is useful include, but are not limited to, typical nuclear, biological, and chemical (NBC) attacks, as well as hazardous materials incidents and training which require actions such as avoidance, response, handling, and cleanup.

The method described herein represents an innovation in the field of EFR training and operations. The purpose of this method is twofold: safe and expeditious EFR passage through/around the hazard(s); and safe and efficient clean up/removal training and operations.

### SUMMARY OF THE INVENTION

This invention utilizes augmented reality (AR) technology to overlay a display of otherwise invisible dangerous materials/hazards onto the real world view in an intuitive, user-friendly format. AR is defined in this application to mean combining computer-generated graphical elements with a real world view (which may be static or changing) and presenting the combined view as a replacement for the real world image. Additionally, these computer-generated graphical elements can be used to present the EFR/trainee/other user with an idea of the extent of the hazard at hand. For example, near the center of a computer-generated element representative of a hazard, the element may be darkened or more intensely colored to suggest extreme danger. At the edges, the element may be light or semitransparent, suggesting an approximate edge to the danger zone where effects may not be as severe.

This data may be presented using a traditional interface such as a computer monitor, or it may be projected into a head-mounted display (HMD) mounted inside an EFR's mask, an SCBA (Self-Contained Breathing Apparatus), HAZMAT (hazard materials) suit, or a hardhat. Despite the method of display, the view of the EFR/trainee's real environment, including visible chemical spills, visible gasses, and actual structural surroundings, will be seen, overlaid or augmented with computer-generated graphical elements (which appear as three-dimensional objects) representative of the hazards. The net result is an augmented reality.

The inventive method is useful for training and retraining of EFR personnel within a safe, realistic environment. Computer-generated graphical elements (which are representations of hazards) are superimposed onto a view of the real training environment and present no actual hazard to the trainee, yet allow the trainee to become familiar with proper procedures within an environment which is more like an actual incident scene.

The invention has immediate applications for both the training and operations aspects of the field of emergency first response; implementation of this invention will result in safer training, retraining, and operations for EFRs involved in hazardous situations. Furthermore, potential applications of this technology include those involving other training and preparedness (i.e., fire fighting, damage control, counter-terrorism, and mission rehearsal), as well as potential for use in the entertainment industry.

### BRIEF DESCRIPTION OF THE DRAWINGS

FIG. 1 Depicts an augmented reality display according to the invention that displays a safe path available to the user by using computer-generated graphical poles to indicate where the dangerous regions are.

FIG. 2 depicts an augmented reality display according to the invention that depicts a chemical spill emanating from a center that contains radioactive materials.

FIG. 3 is a block diagram indicating the hardware components and interconnectivity of a video-based AR system involving an external video mixer.

FIG. 4 is a block diagram indicating the hardware components and interconnectivity of a see-through augmented reality (AR) system.

### DETAILED DESCRIPTION OF THE PREFERRED EMBODIMENTS OF THE INVENTION

This invention involves a method for visualization of hazards utilizing computer-generated three-dimensional representations. The following items and steps are needed to accomplish the method:

A display unit for the user;

Acquisition of an image or view of the real world;

A computer for rendering a three-dimensional representation of one or more hazards;

Combination of the view of the real world with the rendered representation; and

Presentation of the combined (augmented) view to the user.

Display Unit. The inventive method requires a display unit in order for the user to view computer-generated graphical elements representative of hazards overlaid onto a view of the real world—the view of the real world is augmented with the representations of hazards. The net result is an augmented reality.

In the preferred embodiment of the invention, the display unit is a “heads-up” type of display (in which the user's head usually remains in an upright position while using the display unit), preferably a Head-Mounted Display (HMD). There are many varieties of HMDs which would prove acceptable for this method, including see-through and non-see-through types.

There are alternatives to using an HMD as a display unit. The display device could be a “heads-down” type of display, similar to a computer monitor, used within a vehicle (i.e., mounted in the vehicle's interior). The display device could also be used within an aircraft (i.e., mounted on the control panel or other location within a cockpit) and would, for example, allow a pilot or other navigator to “visualize” vortex data and unseen runway hazards (possibly due to poor visibility because of fog or other weather issues). Furthermore, any stationary computer monitor, display devices which are moveable yet not small enough to be considered “handheld,” and display devices which are not specifically handheld but are otherwise carried or worn by the user, could serve as a display unit for this method. In all embodiments, the image of the real world may be static or moving.

The inventive method can also utilize handheld display units. Handheld display units can be either see-through or non-see-through. In one embodiment, the user looks through the “see-through” portion (a transparent or semitransparent surface) of the handheld display device (which can be a monocular or binocular type of device) and views the computer-generated elements projected onto the view of the real surroundings.

Acquisition of a View of the Real World. The preferred embodiment of this inventive method uses a see-though HMD to define a view of the real world. The “see-through” nature of the display device allows the user to “capture” the view of the real world simply by looking through an appropriate part of the equipment. No mixing of real world imagery and computer-generated graphical elements is required—the computer-generated imagery is projected directly over user's view of the real world as seen through a semi-transparent display. This optical-based embodiment minimizes necessary system components by reducing the need for additional hardware and software used to capture images of the real world and to blend the captured real world images with the computer-generated graphical elements.

Embodiments of this method using non-see through display units obtain an image of the real world with a video camera connected to a computer via a video cable. In this case, the video camera may be mounted onto the display unit. Using a commercial-off-the-shelf (COTS) mixing device, the image of the real world is mixed with the computer-generated graphical elements and then presented to the user.

A video-based embodiment of this method could use a motorized camera mount for tracking position and orientation of the camera. System components would include a COTS motorized camera, a COTS video mixing device, and software developed for the purpose of telling the computer the position and orientation of the camera mount. This information is used to facilitate accurate placement of the computer-generated graphical elements within the user's composite view.

External tracking devices can also be used in the video-based embodiment. For example, a GPS tracking system, an optical tracking system, or another type of tracking system would provide the position and orientation of the camera. Furthermore, a camera could be used that is located at a pre-surveyed position, where the orientation of the camera is well known, and where the camera does not move.

It may be desirable to modify the images of reality if the method is using a video-based embodiment. For instance, in situations where a thermal sort of view of reality is desired, the image of the real world can be modified to appear in a manner similar to a thermal view by reversing the video, removing all color information (so that only brightness remains as grayscale), and, optionally, coloring the captured image green.

Computer-Generated Three-Dimensional Graphical Elements as Representations of Hazards. The inventive method utilizes computer-generated three-dimensional graphical elements to represent actual and fictional hazards. The computer-generated imagery is combined with the user's real world view such that the user visualizes hazards, seen and unseen, real and unreal, within his/her immediate surroundings. Furthermore, not only is the hazard visualized in a manner which is harmless to the user, the visualization of the hazard provides the user with information regarding location, size, and shape of the hazard; location of safe regions (such as a path through a region that has been successfully decontaminated of a biological or chemical agent) in the immediate vicinity of the hazard; and the severity of the hazard. The representation of the hazard can look and sound like the hazard itself (i.e., a different representation for each hazard type); or it can be an icon indicative of the size and shape of the appropriate hazard. The representation can be a textual message, which would provide information to the user, overlaid onto a view of the real background, in conjunction with the other, non-textual graphical elements, if desired.

The representations can also serve as indications of the intensity and size of a hazard. Properties such as fuzziness, fading, transparency, and blending can be used within a computer-generated graphical element to represent intensity and spatial extent and edges of hazard(s). For example, a representation of a hazardous material spill could show darker colors at the most heavily saturated point of the spill and fade to lighter hues and greater transparency at the edges, indicating less severity at location of the spill at the edges.

Audio warning components, appropriate to the hazard(s) being represented, also can be used in the invention. Warning sounds can be presented to the user along with the mixed view of rendered graphical elements with reality. Those sounds may have features that include, but are not limited to, chirping, intermittent, steady frequency, modulated frequency, and/or changing frequency.

The computer-generated representations can be classified into two categories: reproductions and indicators. Reproductions are computer-generated replicas of an element, seen or unseen, which would pose a danger to a user if it were actually present. Reproductions also visually and audibly mimic actions of hazards (e.g., a computer-generated representation of water might turn to steam and emit a hissing sound when coming into contact with a computer-generated representation of fire). Representations which would be categorized as reproductions can be used to indicate appearance, location and/or actions of many visible hazards, including, but not limited to, fire, water, smoke, heat, radiation, chemical spills (including display of different colors for different chemicals), and poison gas. Furthermore, reproductions can be used to simulate the appearance, location and actions of unreal hazards and to make invisible hazards visible. This is useful for many applications, such as training scenarios where actual exposure to a hazard is too dangerous, or when a substance, such as radiation, is hazardous and invisible. Representations which are reproductions of normally invisible hazards maintain the properties of the hazard as if the hazard were visible—invisible gas has the same movement properties as visible gas and will act accordingly in this method. Reproductions which make normally invisible hazards visible include, but are not limited to, steam, heat, radiation, and poison gas.

The second type of representation is an indicator. Indicators provide information to the user, including, but not limited to, indications of hazard locations (but not appearance), warnings, instructions, or communications. Indicators may be represented in the form of text messages and icons, as described above. Examples of indicator information may include procedures for dealing with a hazardous material, location of a member of a fellow EFR team member, or a message noting trainee death by fire, electrocution, or other hazard (useful for training purposes).

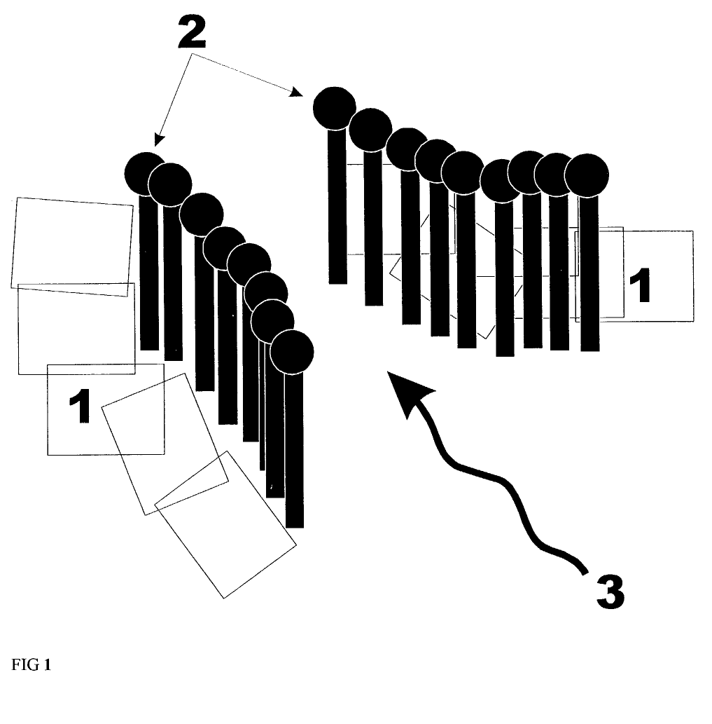

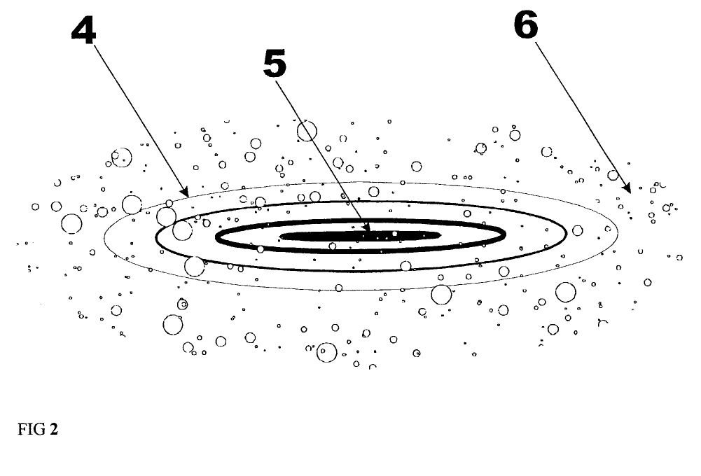

The inventive method utilizes representations which can appear as many different hazards. For example, hazards and the corresponding representations may be stationary three-dimensional objects, such as signs or poles. They could also be moving hazards, such as unknown liquids or gasses that appear to be bubbling or flowing out of the ground. Some real hazards blink (such as a warning indicator which flashes and moves) or twinkle (such as a moving spill which has a metallic component); the computer-generated representation of those hazards would behave in the same manner. In FIG. 1, an example of a display resulting from the inventive method is presented, indicating a safe path to follow 3 in order to avoid coming in contact with a chemical spill 1 or other kind of hazard 1 by using computer-generated poles 2 to demarcate the safe area 3 from the dangerous areas 1. FIG. 2 shows a possible display to a user where a chemical/radiation leak 5 is coming out of the ground and visually fading to its edge 4, and simultaneously shows bubbles 6 which could represent the action of bubbling (from a chemical/biological danger), foaming (from a chemical/biological danger), or sparkling (from a radioactive danger).

Movement of the representation of the hazard may be done with animated textures mapped onto three-dimensional objects. For example, movement of a “slime” type of substance over a three-dimensional surface could be accomplished by animating to show perceived outward motion from the center of the surface. This is done by smoothly changing the texture coordinates in OpenGL, and the result is smooth motion of a texture mapped surface.

The representations describing hazards and other information may be placed in the appropriate location by several methods. In one method, the user can enter information (such as significant object positions and types) and representations into his/her computer upon encountering hazards or victims while traversing the space, and can enter such information to a database either stored on the computer or shared with others on the scene. A second, related method would be one where information has already been entered into a pre-existing, shared database, and the system will display representations by retrieving information from this database. A third method could obtain input data from sensors such as a video cameras, thermometers, motion sensors, or other instrumentation placed by EFRs or pre-installed in the space.

The rendered representations can also be displayed to the user without a view of the real world. This would allow users to become familiar with the characteristics of a particular hazard without the distraction of the real world in the background. This kind of view is known as virtual reality (VR).

Use in Training Scenarios and in Operations. The inventive method for utilizing computer-generated three-dimensional representations to visualize hazards has many possible applications. Broadly, the representations can be used extensively for both training and operations scenarios.

Many training situations are impractical or inconvenient to reproduce in the real world (e.g., flooding in an office), unsafe to reproduce in the real world (e.g., fires aboard a ship), or impossible to produce in the real world (e.g., “see” otherwise invisible radioactivity, or “smell” otherwise odorless fumes). Computer-generated representations of these hazards will allow users to learn correct procedures for alleviating the incident at hand, yet maintain the highest level of trainee and instructor safety. Primary applications are in the training arena where response to potential future dangerous or emergencies must be rehearsed.

Training with this method also allows for intuitive use of the method in actual operations. Operational use of this method would use representations of hazards where dangerous unseen objects or events are occurring, or could occur, (e.g., computer-generated visible gas being placed in the area where real unseen gas is expected to be located). Applications include generation of computer-generated elements while conducting operations in dangerous and emergency situations.

Combining computer-generated graphical elements with the view of the real world and presenting it to the user. Once the computer renders the representation, it is combined with the real world image. In the preferred optical-based embodiment, the display of the rendered image is on a see-through HMD, which allows the view of the real world to be directly visible to the user through the use of partial mirrors, and to which the rendered image is added. Video-based embodiments utilizing non-see through display units require additional hardware and software for mixing the captured image of the real world with the representation of the hazard.

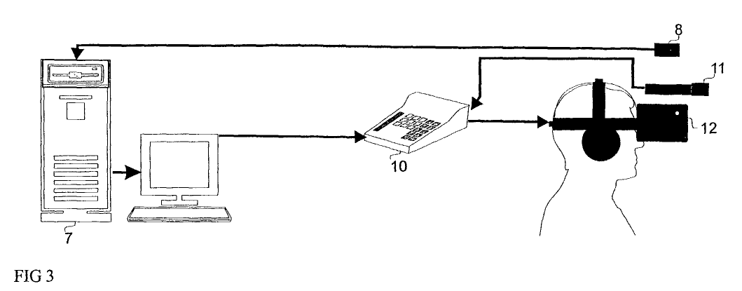

FIG. 3 is a block diagram indicating the hardware components of an augmented reality (AR) system that accomplishes the method. The computer 7 in the FIG. 3 is diagrammed as but not limited to a desktop PC. Wearable computers or laptops/notebooks may be used for portability, high-end graphics workstations may be used for performance, or other computing form factors may be used for the benefits they add to such a system. Imagery from a head-worn video camera 11 is mixed in video mixer 10 via a linear luminance key with computer-generated (CG) output that has been converted to NTSC using VGA-to-NTSC encoder (not shown). Two cameras (not shown) can be used for stereo imagery. The luminance key removes white portions of the computer-generated imagery and replaces them with the camera imagery. Black computer graphics remain in the final image, and luminance values for the computer graphics in between white and black are blended appropriately with the camera imagery. The final mixed image (camera video combined with computer graphics) is displayed to a user in head-mounted display (HMD) 12. The position tracker 8 attached to the video camera 11 is used by the computer 7 to determine the position and orientation of the viewpoint of the camera 11, and the computer 7 will render graphics to match the position and orientation.

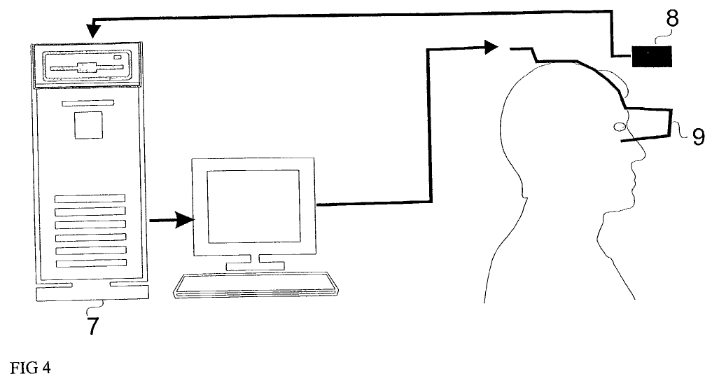

One alternative embodiment to the display setup diagrammed in FIG. 3 is the use of optical see-through AR as shown in FIG. 4. In such an embodiment, camera 11 and video mixer 10 are absent, and HMD 9 is one that allows its wearer to see computer graphics overlaid on his/her direct view of the real world. This embodiment is preferred as it has less equipment and can allow for a better view of the real world.

What is claimed is:

1. A method of visualization of hazards, comprising:
providing a display unit for the user;
providing motion tracking hardware;
using the motion tracking hardware to determine the location and direction of the viewpoint to which the computer-generated three-dimensional graphical elements are being rendered;
providing an image or view of the real world;
using a computer to generate three-dimensional graphical elements as representations of hazards;
rendering the computer-generated graphical elements to correspond to the user's viewpoint;
creating for the user a mixed view comprised of an actual view of the real world as it appears in front of the user, where graphical elements can be placed anywhere in the real world and remain anchored to that place in the real world regardless of the direction in which the user is looking, wherein the rendered graphical elements are superimposed on the actual view, to accomplish an augmented reality view of representations of hazards in the real world; and
presenting the augmented reality view, via the display unit, to the user.

2. The method of claim 1 in which the display unit is selected from the group of display units consisting of a heads-up display, a Head Mounted Display (HMD), a see-through HMD, and a non-see-through HMD.

3. The method of claim 1 in which the display unit is selected from the group of display units consisting of a heads-down-display, a display unit that is moveable, but not held, by the user, a fixed computer monitor, a display unit that is used in a vehicle, and a display unit that is used in an aircraft.

4. The method of claim 1 in which the display unit is selected from the group of display units consisting of a handheld display device, a handheld see-through device, a handheld binocular type of display, a handheld monocular type of display, a handheld non-see-through device, and a display unit that is carried by a user.

5. The method of claim 1 in which providing an image or view of the real world comprises capturing an image with a video camera that is mounted to the display unit.

6 The method of claim 1 in which the image of the real world is a static image.

7. The method of claim 1 in which the image of the real world is from a ground-based stationary imaging sensor from a known viewpoint.

8. The method of claim 1 in which the image of the real world has been modified to appear approximately like a thermal view of the real world would appear.

9. The method of claim 1 in which the motion tracking hardware is selected from the group of motion tracking hardware consisting of a motorized camera mount, an external tracking system, and a Global Positional System.

10. The method of claim 1 in which the representations are designed to be reproductions to mimic the appearance and actions of actual hazards.

11. The method of claim 1 in which the representations are designed to be indicators of actual hazards, and to convey their type and positions.

12. The method of claim 1 in which the representations are used to indicate a safe region in the vicinity of a hazard.

13. The method of claim 1 in which the representations are entered into the computer interactively by a user.

14. The method of claim 1 in which the representations are automatically placed using a database of locations.

15. The method of claim 1 in which the representations are automatically placed using input from sensors.

16. The method of claim 1 in which the representations are static 3D objects.

17 The method of claim 1 in which the representations are animated textures mapped onto 3D objects.

18 The method of claim 1 in which the representations are objects that appear to be emanating out of the ground.

19. The method of claim 1 in which the representations blink or have a blinking component.

20. The method of claim 1 in which the representations represent at least the location of a hazard selected from the group of hazards consisting of visible fire, visible water, visible smoke, poison gas, heat, chemicals and radiation.

21. The method of claim 1 in which the representations are created to appear and act to mimic how a hazard selected from the group of hazards consisting of fire in that location would appear and act, water in that location would appear and act, smoke in that location would appear and act, unseen poison gas in that location would act, unseen heat in that location would act, and unseen radiation in that location would act.

22. The method of claim 1 in which the rendered computer-generated three-dimensional graphical elements are representations displaying an image property selected from the group of properties consisting of fuzziness, fading, transparency, and blending, to represent the intensity, spatial extent, and edges of at least one hazard.

23. The method of claim 1 in which the rendered computer-generated three-dimensional graphical elements are icons which represent hazards.

24. The method of claim 1 in which information about the hazard is displayed to the user via text overlaid onto a view of a real background.

25. The method of claim 1 further comprising generating for the user an audio warning component appropriate to at least one hazard being represented.

26. The method of claim 1 in which the representations are used in operations.

27. The method of claim 1 in which the representations are used in training.

28. The method of claim 1 in which the representations are displayed without a view of the real world.
